(19) United States
(12) Patent Application Publication
(10) Pub. No.: US 2024/0392112 A1
(43) Pub. Date: Nov. 28, 2024

(54) Biodegradable Polymer Composition Containing High Levels of Strength Adjuvant Particles

(71) Applicant: Celanese International Corporation, Irving, TX (US)

(72) Inventors: Guodong Deng, Florence, KY (US); Rongfu Li, Narrows, VA (US); Jonathan Caterino, Union, KY (US); Christopher McGrady, Walton, KY (US); Michael Combs, Shady Spring, WV (US)

(21) Appl. No.: 18/672,619

(22) Filed: May 23, 2024

Related U.S. Application Data
(60) Provisional application No. 63/504,289, filed on May 25, 2023.

(51) Int. Cl. C08L 1/12; C08K 3/26; C08K 3/34; C08K 5/103; C08K 13/02

(52) U.S. Cl. CPC C08L 1/12; C08K 13/02; C08K 2003/265; C08K 2003/343; C08K 5/103; C08L 2201/06; C08L 2203/10; C08L 2205/06

(57) ABSTRACT

A polymer composition is disclosed formed from a cellulose ester polymer, a plasticizer, and at least one strength adjuvant. The strength adjuvant can comprise filler particles. The filler particles are added to the polymer composition in relatively great amounts, such as in amounts greater than 30% by weight.

### RELATED APPLICATIONS

The present application is based upon and claims priority to U.S. Provisional Patent Application Ser. No. 63/504,289, having a filing date of May 25, 2023, which are all incorporated herein by reference.

### BACKGROUND

Each year, the global production of plastics continues to increase. Over one-half of the amount of plastics produced each year are used to produce plastic bottles, containers, drinking straws, and other single-use items.

The discarded, single-use plastic articles, including plastic drinking bottles and straws, are typically not recycled and end up in landfills. In addition, many of these items are not properly disposed of and end up in streams, lakes, and in the oceans around the world.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally-friendly polymers because they are recyclable, degradable and derived from renewable resources, such as wood pulp. Problems have been experienced, however, in melt processing cellulose ester polymers, such as cellulose acetate polymers. In addition, the melting temperature of cellulose ester polymers is very close to the degradation temperature, further creating obstacles to melt processing the polymers successfully. Further, cellulose ester polymers can create and release acid components, such as acetic acid during processing and after the polymer articles are formed. These acidic components can not only cause corrosion in the polymer processing equipment, but can also create unwanted and undesirable odors.

In view of the above, a need currently exists for biodegradable polymer compositions containing a cellulose acetate polymer that is substantially biodegradable and has reduced acetic acid emissions. A need also exists for a biodegradable cellulose acetate polymer composition that has increased strength characteristics.

### SUMMARY

In general, the present disclosure is directed to a polymer composition containing a cellulose ester polymer in combination with at least one plasticizer and one or more strength adjuvants. Each strength adjuvant comprises filler particles. The one or more strength adjuvants are added in relatively great amounts. It was surprisingly discovered that adding great amounts of the one or more strength adjuvants can actually improve processing of the polymer composition while dramatically increasing strength. In addition, the strength adjuvants, especially in the amounts loaded into the polymer composition, substantially increase the biodegradation rate of polymer articles made from the polymer composition. In addition, the one or more strength adjuvants can also reduce acid emissions, such as acetic acid emissions. The polymer composition is well suited for producing polymer articles, such as cutlery, beverage holders, other plastic containers, drinking straws, hot beverage pods, automotive parts, consumer appliance parts, and the like.

In one aspect, the present disclosure is directed to a polymer composition containing a cellulose ester polymer. The cellulose ester polymer, for instance, can be primarily cellulose diacetate. The cellulose ester polymer is combined with a plasticizer, such as triacetin, polyethylene glycol, polycaprolactone, or mixtures thereof. In accordance with the present disclosure, the polymer composition contains one or more strength adjuvants. Each strength adjuvant comprises filler particles, such as mineral filler particles. The one or more strength adjuvants are present in the polymer composition in an amount greater than 20% by weight, such as in an amount greater than about 24% by weight, such as in an amount greater than about 28% by weight, such as in an amount greater than about 30% by weight, such as in an amount greater than about 34% by weight, such as in an amount greater than about 38% by weight, such as in an amount greater than about 40% by weight, such as in an amount greater than about 41% by weight, such as in an amount greater than about 42% by weight, such as in an amount greater than about 43% by weight, and in an amount less than about 55% by weight, such as in an amount less than about 50% by weight. The polymer composition can display a tensile strength of greater than about 35 MPa and a tensile modulus of greater than about 3,000 MPa.

For example, the polymer composition of the present disclosure can display a tensile strength of greater than about 38 MPa, such as greater than about 40 MPa, such as greater than about 42 MPa, such as greater than about 45 MPa, such as greater than about 48 MPa, such as greater than about 50 MPa, and less than about 150 MPa. The polymer composition can display a tensile modulus of greater than about 3,500 MPa, such as greater than about 4,000 MPa, such as greater than about 4,500 MPa, such as greater than about 5,000 MPa, such as greater than about 5,500 MPa, such as greater than about 6,000 MPa, such as greater than about 6,500 MPa, such as greater than about 7,000 MPa, and less than about 20,000 MPa.

Various different strength adjuvants can be incorporated into the polymer composition of the present disclosure. In one aspect, the strength adjuvant can comprise a magnesium compound, such as a hydrated magnesium silicate, a hydrotalcite, or mixtures thereof.

In other embodiments, the one or more strength adjuvants may comprise an aluminum compound, a zinc compound, or a calcium compound. The above adjuvants may be used alone or in mixtures and may be combined with a magnesium compound.

In one aspect, the one or more strength adjuvants comprises calcium carbonate.

In still another embodiment, the one or more strength adjuvants may comprise a metal oxide, such as magnesium oxide, zinc oxide, or mixtures thereof. In still another aspect, the strength adjuvant may comprise a zeolite. In one aspect, the polymer composition contains at least two strength adjuvants, such as at least three strength adjuvants.

In one aspect, the polymer composition contains a cellulose acetate polymer in an amount from about 28% by weight to about 50% by weight and contains one or more plasticizers in an amount from about 10% by weight to about 28% by weight. The one or more strength adjuvants can be present in an amount from about 22% by weight to about 55% by weight.

The present disclosure is also directed to articles made from the polymer composition, including molded articles.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer compositions containing a cellulose ester polymer in combination with one or more strength adjuvants. The one or more strength adjuvants comprise filler particles. The strength adjuvants are contained in the polymer composition at very high loading levels that have been found to provide various benefits and advantages, especially with respect to the mechanical properties and physical properties of articles made from the composition.

In the past, various different inorganic fillers were combined with cellulose acetate polymers in producing polymer articles. The fillers, however, were added at relatively low amounts, such as at amounts less than about 15% by weight. It was believed that adding high amounts of fillers would make it difficult to process the polymer compositions and would lead to a decrease in various properties.

The present inventors, however, discovered that great amounts of fillers or strength adjuvants can be incorporated into cellulose ester polymer compositions in an efficient manner without experiencing processing dilemmas or problems. In addition, the resulting polymer composition can display enhanced strength properties when molded into articles. Further, polymer compositions formulated in accordance with the present disclosure have enhanced biodegradation properties, while displaying an increased heat deflection temperature. Ultimately, the polymer composition is well suited for producing all different types of articles that are biodegradable and compostable.

In one aspect, the polymer composition of the present disclosure contains at least one cellulose ester polymer, at least one strength adjuvant in amounts greater than used conventionally, at least one plasticizer, and optionally at least one other ingredient or component. As described above, polymer compositions formulated in accordance with the present disclosure have an excellent balance of properties. For instance, the polymer composition can display a tensile strength of greater than about 38 MPa, such as greater than about 40 MPa, such as greater than about 42 MPa, such as greater than about 45 MPa, such as greater than about 48 MPa, such as greater than about 50 MPa, and less than about 130 MPa. The polymer composition can also display tensile modulus of greater than about 3,500 MPa, such as greater than about 4,000 MPa, such as greater than about 4,500 MPa, such as greater than about 5,000 MPa, such as greater than about 5,500 MPa, such as greater than about 6,000 MPa, such as greater than about 6,500 MPa, such as greater than about 7,000 MPa, and generally less than about 15,000 MPa. In addition, the polymer composition can display a heat deflection temperature (DTUL) at 1.8 MPa of greater than about 50° C., such as greater than about 52° C., such as greater than about 55° C., such as greater than about 57° C., such as greater than about 60° C., such as greater than about 62° C., such as greater than about 65° C., such as greater than about 67° C., such as even greater than about 70° C. and less than about 110° C.

While still possessing the above strength properties and heat deflection temperature characteristics, the polymer composition of the present disclosure can also have enhanced biodegradability and compostability. For instance, the polymer composition of the present disclosure can meet the requirements of industrial compostability according to EN Test 13432.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) \\ where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose acetate is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight. The cellulose acetate is generally present in the polymer composition in an amount less than about 85% by weight, such as in an amount less than about 80% by weight, such as in an amount less than about 75% by weight, such as in an amount less than about 70% by weight, such as in an amount less than about 65% by weight.

A cellulose acetate as described above can be combined with one or more plasticizers. Plasticizers particularly well suited for use in the polymer composition include triacetin, monoacetin, diacetin, and mixtures thereof. Other plasticizers particularly well suited for use in the polymer composition of the present disclosure include glycols such as polyethylene glycol. The composition can also include a bio-based polyester plasticizer, such as a polycaprolactone. The above plasticizers can also be used in combination. For instance, the polymer composition can contain triacetin in combination with a polyethylene glycol or a polycaprolactone. In still another embodiment, a polyethylene glycol can be combined with a polycaprolactone.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

As described above, the polymer composition can also contain a bio-based plasticizer that is a bio-based polyester, such as a bio-based aliphatic polyester having a relatively low molecular weight. For example, the plasticizer can comprise a bio-based polyester polymer having a number average molecular weight of less than about 12,000 g/mol, such as less than about 10,000 g/mol, such as less than about 8,000 g/mol, such as less than about 6,000 g/mol, such as less than about 4,000 g/mol, such as less than about 2,500 g/mol, such as less than about 1,000 g/mol, such as less than about 900 g/mol, such as less than about 800 g/mol, and generally greater than about 500 g/mol. In one embodiment, the bio-based plasticizer is a polycaprolactone having a number average molecular weight of 1000 g/mol or less. Alternatively, the bio-based plasticizer may be a polyhydroxyalkanoate having a number average molecular weight of 1000 g/mol.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 8% to about 40% by weight, such as in an amount from about 12% to about 35% by weight. In one aspect, one or more plasticizers can be present in the polymer composition in an amount of about 22% or less, such as in an amount of about 20% or less, such as in an amount of about 19% or less, such as in an amount of about 18% or less, such as in an amount of about 10% or less. One or more plasticizers are generally present in an amount from about 5% or greater, such as in an amount of about 10% or greater.

The cellulose acetate can be present in relation to the plasticizer such that the weight ratio between the cellulose acetate and the one or more plasticizers is from about 60:40 to about 85:15, such as from about 65:35 to about 75:25. In one embodiment, the cellulose acetate to plasticizer weight ratio is about 70:30.

In accordance with the present disclosure, the cellulose acetate and one or more plasticizers are combined with one or more strength adjuvants comprising filler particles. The one or more strength adjuvants can be incorporated into the polymer composition in an amount sufficient to increase the physical and mechanical properties of articles made from the composition. The strength adjuvants can also increase the biodegradation rate of the composition and increase the heat deflection temperature of the composition. The one or more adjuvants are added in relatively great amounts to the polymer composition. For instance, in one aspect, one or more strength adjuvants are added to the polymer composition in an amount of greater than 20% by weight, such as in an amount of about 30% by weight or greater.

Strength adjuvants that can be incorporated into the polymer composition include magnesium compounds, aluminum compounds, zinc compounds, calcium compounds, and mixtures thereof. In one aspect, the compound can be a metal oxide, such as magnesium oxide, zinc oxide, and the like. The strength adjuvant can also be calcium carbonate particles. In one aspect, the strength adjuvant can comprise zeolite particles or silicate particles. In one aspect, the strength adjuvant can comprise any suitable mineral filler and can comprise a carbonate, a hydroxide, an alkali metal salt, an alkaline earth metal salt, or the like.

In general, the strength adjuvant can have an average particle size of less than about 30 microns, such as less than about 20 microns, such as less than about 10 microns, such as less than about 8 microns, such as less than about 6 microns, such as less than about 4 microns, such as less than about 2 microns, such as even less than about 1 micron. The average particle size is generally greater than about 0.01 microns, such as greater than about 0.5 microns, such as greater than about 1 micron, such as greater than about 2 microns, such as greater than about 4 microns.

In one particular embodiment, the strength adjuvant can comprise talc particles. Talc (CAS No. 14807-96-6) is a sheet silicate having the chemical composition Mg₃[Si₄O₁₀(OH)₂], which, according to the polymorph, crystallizes as talc-1A in the triclinic crystal system or as talc-2M in the monoclinic crystal system. In one embodiment, talc present in the polymer composition is a microcrystalline talc having a relatively small particle size. Unlike when talc is used as a filler, the talc particles can be uncoated.

In one embodiment, microcrystalline talc having a median particle size d50 determined using a SediGraph in the range from 0.5 to 10 μm is used, such as in the range from 1.0 to 7.5 μm, such as in the range from 1.5 to 5.0 μm, such as in the range from 1.8 to 4.5 μm.

The particle size of the talc is determined by sedimentation in a fully dispersed state in an aqueous medium with the aid of a “Sedigraph 5100” as supplied by Micrometrics Instruments Corporation, Norcross, Ga., USA. The Sedigraph 5100 delivers measurements and a plot of cumulative percentage by weight of particles having a size referred to as “equivalent sphere diameter” (esd), minus the given esd values.

The median particle size d50 is the value determined from the particle esd at which 50% by weight of the particles have an equivalent sphere diameter smaller than this d50 value. The underlying standard is ISO 13317-3.

In one embodiment, microcrystalline talc is defined via the BET surface area. Microcrystalline talc for use in accordance with the present disclosure can have a BET surface area, which can be determined in analogy to DIN ISO 9277, in the range from 5 to 25 m²·g⁻¹, such as in the range from 10 to 18 m²·g⁻¹, such as in the range from 12 to 15 m²·g⁻¹.

The talc particles incorporated into the polymer composition can contain talc that has a purity of greater than 96% by weight, such as in an amount greater than 97% by weight, such as in an amount greater than 98% by weight, such as in an amount greater than 99% by weight. The talc particles can contain chlorite in an amount less than about 2% by weight, such as in an amount less than about 1% by weight, such as in an amount less than about 0.1% by weight, can contain dolomite in an amount less than about 2% by weight, such as in an amount less than about 1% by weight, such as in an amount less than about 0.1% by weight, and can contain magnesite in an amount less than about 2% by weight, such as in an amount less than about 1% by weight, such as in an amount less than about 0.5% by weight, such as in an amount less than about 0.1% by weight. In one embodiment, the talc particles can be free of chlorite, can be free of dolomite, can be free of magnesite, or can be free of all the above or at least two of the above.

In an alternative embodiment, the strength adjuvant can comprise a hydrotalcite. Any suitable hydrotalcite may be used. Hydrotalcite is a nonstoichiometric compound that, in one aspect, can be represented by a general formula: [Mg₁₋ₓAlₓ(OH)_{z}]^{x+}[(CO3)_{x/2}·m(H2O)]^{x-} and is an inorganic material having a layered crystal structure that can include a positively charged base layer and a negatively charged intermediate layer. In the one embodiment above, x represents a number in a range greater than 0 and less than or equal to 0.5, such as 0.33. Natural hydrotalcite can be represented by Mg6Al2(OH)16CO3·4H20. One example of a synthesized hydrotalcite is Mg45Al2(OH)13CO3·3·5H20. The hydrotalcite can have an average particle size (d50) of less than 1 micron, such as less than about 0.6 microns and greater than about 0.1 microns.

One or more strength adjuvants can be incorporated into the polymer composition generally in an amount greater than 20% by weight, such as in an amount greater than about 22% by weight, such as in an amount greater than about 26% by weight, such as in an amount greater than about 28% by weight, such as in an amount greater than about 30% by weight, such as in an amount greater than about 32% by weight, such as in an amount greater than about 34% by weight, such as in an amount greater than about 36% by weight, such as in an amount greater than about 38% by weight, such as in an amount greater than about 40% by weight, such as in an amount greater than about 41% by weight, such as in an amount greater than about 42% by weight, such as in an amount greater than about 43% by weight. One or more strength adjuvants are generally present in the polymer composition in an amount less than about 60% by weight, such as in an amount less than about 55% by weight, such as in an amount less than about 50% by weight.

In addition to one or more cellulose ester polymers, one or more plasticizers, and one or more strength adjuvants, the polymer composition of the present disclosure can contain various other components. For instance, in one embodiment, the polymer composition can contain an acidic species. The acidic species, for instance, can serve as a catalyst that can attach to the cellulose ester polymer and serve as a crosslinking agent. The acidic species can also cause chain scission of the cellulose ester polymer chains for creating reactive sites and/or for adjusting the flow properties of the polymer.

Various different types of acidic species may be used. In one embodiment, the acidic species includes terminal hydroxyl groups, such as terminal carboxyl groups. For instance, the acidic species can contain greater than two, such as greater than three, such as greater than four, and generally less than about eight, such as less than about six terminal hydroxyl groups.

In one aspect, the acidic species can be an organic acid. One particular organic acid well suited for use in the composition of the present disclosure is citric acid. Other acids well suited for use in the polymer composition include stearic acid, tartaric acid, oxalic acid, and combinations of any of the above. In still other embodiments, the catalyst can be palmitic acid, linoleic acid, lactic acid, acetic acid, formic acid, malic acid, peracetic acid, and the like. In one embodiment, citric acid may be used in combination with another organic acid, such as stearic acid and/or oxalic acid.

The amount of the acidic species incorporated into the polymer composition can depend upon various factors including the molecular weight of the cellulose ester polymer, the amount and type of plasticizer that may be incorporated into the composition, and the desired resulting melt flow rate of the composition. In general, one or more acid species can be present in the composition in an amount from about 0.001% by weight to about 5% by weight, including all increments of 0.01% by weight therebetween. For example, one or more acid species can be present in the polymer composition in an amount greater than about 0.008% by weight, such as in an amount greater than about 0.01% by weight. One or more acid species can be present in the composition in an amount less than about 3% by weight, such as in an amount less than about 2% by weight, such as in an amount less than about 1.5% by weight, such as in an amount less than about 1% by weight, such as in an amount less than about 0.5% by weight, such as in an amount less than about 0.3% by weight, such as in an amount less than about 0.1% by weight.

In one aspect, the polymer composition can contain an odor masking agent. The odor masking agent can comprise a phenolic aldehyde, an alkoxy phenolic compound, a terpene, or a terpene derivative.

For example, in one aspect, the odor masking agent can comprise vanillin or a compound based on vanillin. For example, in one embodiment, the odor masking agent comprises an alkyl vanillin, such as ethyl vanillin. In other embodiments, various other vanillin derivatives can be used.

In another embodiment, the odor masking agent can comprise a geraniol. Geraniol is a monoterpenoid. Geraniol derivatives can also be used as the odor masking agent, such as geranyl acetate. Other odor masking agents that can be used in accordance with the present disclosure include guaiacol or eugenol. Guaiacol is a monomethoxybenzene that includes a phenol with a methoxy substituent. Eugenol, on the other hand, is an allyl chain-substituted guaiacol. Eugenol is a phenylpropanoid.

In still other embodiments, the odor masking agent can comprise various other phenol and furan derivatives. Further examples of odor masking agents, for instance, include syringol, syringaldehyde, pyrogallol, and mixtures thereof.

For instance, one or more odor masking agents can be present in the polymer composition generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight, such as in an amount less than about 0.6% by weight, such as in an amount less than about 0.4% by weight. In many applications, one or more odor masking agents can be present in the polymer composition in an amount less than about 0.3% by weight, such as in an amount less than about 0.2% by weight, such as in an amount less than about 0.1% by weight, such as in an amount less than about 0.08% by weight, such as in an amount less than about 0.05% by weight. One or more odor masking agents are generally present in the polymer composition in an amount greater than about 0.001% by weight, such as in an amount greater than about 0.007% by weight, such as in an amount greater than about 0.01% by weight.

Optionally, the polymer composition can also contain a bio-based polymer.

As used herein, a “bio-based” polymer or plasticizer refers to a polymer, oligomer, or compound produced from at least partially renewable biomass sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process. Although a cellulose ester polymer can be considered a bio-based polymer, the term herein refers to other bio-based substances that can be combined with cellulose ester polymers.

In one aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof.

In one aspect, the physical properties of the cellulose acetate can be particularly improved if at least one bio-based polymer is combined with the cellulose acetate that has a low glass transition temperature and/or is amorphous or is semi-crystalline. For example, a bio-based polymer can be selected for combining with the cellulose acetate that is completely or substantially amorphous or has a low degree of crystallinity. The degree of crystallinity is the fraction of the polymer that exists in an orderly state, having a lattice structure. For example, the bio-based polymer combined with the cellulose acetate can have a crystallinity of less than about 30%, such as less than about 25%, such as less than about 20%, such as less than about 15%, such as less than about 10%, such as less than about 5%. The degree of crystallinity can be determined using X-ray and electron diffraction, differential scanning calorimetry, infrared absorption (FTIR) or Raman spectroscopy.

The at least one bio-based polymer combined with the cellulose acetate can also have a relatively low glass transition temperature. For instance, the glass transition temperature of the bio-based polymer can be less than about 40° C., such as less than about 20° C., such as less than about 10° C., such as less than about 5° C., such as less than about 0° C., such as less than about −5° C., such as less than about −10° C., such as less than about −20° C. The glass transition temperature (Tg) is generally greater than about −40° C., such as greater than about −30° C.

In comparison, the glass transition temperature of cellulose acetate is generally from 160° C. to 180° C. Differences in glass transition temperatures can lead to compatibility issues. However, to the contrary, the use of a bio-based polymer with a low glass transition temperature and/or low crystallinity has been found to not only be compatible with cellulose acetate, but also improves many physical properties of the cellulose acetate including elongation to break and toughness. The addition of the bio-based polymer as described above can also reduce the flexural modulus.

In one aspect, the at least one bio-based polymer combined with the cellulose acetate is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4-hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-CO-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

In one embodiment of the present disclosure, a cellulose acetate is combined with a PHA that has a crystallinity of about 25% or less and has a low glass transition temperature. For instance, the glass transition temperature can be less than about 10° C., such as less than about 5° C., such as less than about 0° C., such as less than about −5° C., and generally greater than about −40° C., such as greater than about −20° C. Such PHAs can dramatically reduce the stiffness properties of the cellulose acetate, thereby increasing the elongation properties and decreasing the flexural modulus properties. As used herein, the glass transition temperature can be determined by dynamic mechanical analysis in accordance with ASTM Test E1640-09.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular embodiment, the polylactic acid has the following general structure:

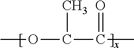

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

The polylactic acid may also have an apparent viscosity of from about 50 to about 600 Pascal seconds (Pa-s), in some embodiments from about 100 to about 500 Pa·s, and in some embodiments, from about 200 to about 400 Pa·s, as determined at a temperature of 190° C. and a shear rate of 1000 sec⁻¹. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

Another bio-based polymer that may be combined with cellulose acetate alone or in conjunction with other bio-based polymers is polycaprolactone having a molecular weight higher than a polycaprolactone plasticizer. Polycaprolactone, similar to PHAs, can be formulated to have a relatively low glass transition temperature. The glass transition temperature, for instance, can be less than about 10° C., such as less than about −5° C., such as less than about −20° C., and generally greater than about −60° C. The polymers can be produced so as to be amorphous or semi-crystalline. The crystallinity of the polymers can be less than about 50%, such as less than about 25%.

Polycaprolactones can be made having a number average molecular weight of generally greater than about 5,000, such as greater than about 8,000, and generally less than about 15,000, such as less than about 12,000.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

The polymer composition of the present disclosure may optionally contain various other additives and ingredients. For instance, the polymer composition may contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN@ available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In one embodiment, the polymer composition contains an antioxidant comprising a phosphorus compound, particularly a phosphite. For instance, in one embodiment, the antioxidant can be a diphosphite. For example, in one embodiment, the antioxidant is a pentaerythritol diphosphite, such as bis(2,4-dicumylphenyl) pentaerythritol diphosphite. The antioxidant can be present in the polymer composition generally in an amount less than about 2% by weight, such as in an amount less than about 1% by weight, such as in an amount less than about 0.5% by weight, such as in an amount less than about 0.3% by weight. The antioxidant can be present in the polymer composition generally in an amount greater than about 0.05% by weight, such as in an amount greater than about 0.08% by weight, such as in an amount greater than about 0.1% by weight, such as in an amount greater than about 0.13% by weight.

Once polymer compositions are formulated in accordance with the present disclosure, in one embodiment, the different components or ingredients are combined together in an extruder and formed into pellets that are then later used in molding processes, such as injection molding. In one aspect, one or more plasticizers are injected at multiple sites along the length of the extruder. For instance, in one aspect, the plasticizer is added to the polymer composition at two different locations along the length of the extruder. It was discovered that adding the plasticizer at multiple locations can help incorporate greater amounts of filler particles into the polymer composition.

The polymer composition of the present disclosure can be formed into any suitable polymer article using any technique known in the art. For instance, polymer articles can be formed from the polymer composition through extrusion, injection molding, blow molding, and the like.

Polymer articles that may be made in accordance with the present disclosure include drinking straws, beverage holders, automotive parts, knobs, door handles, consumer appliance parts, and the like.

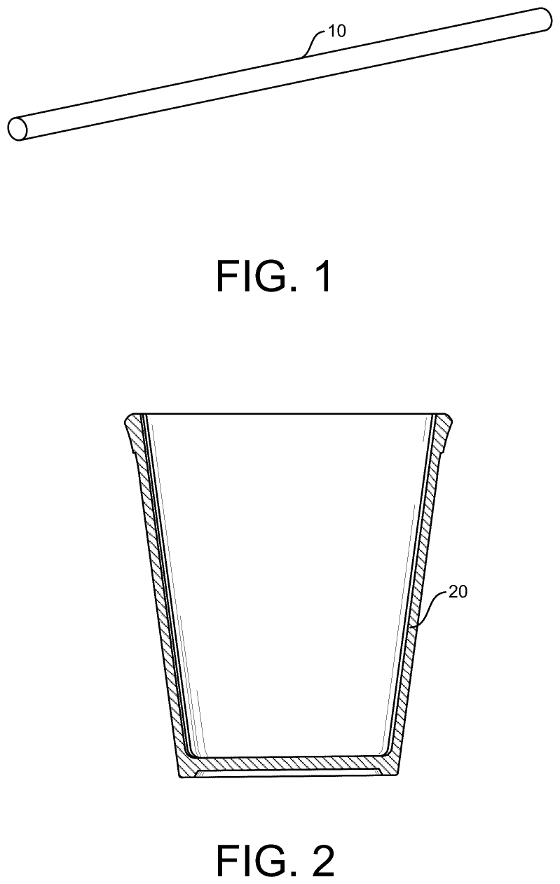

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

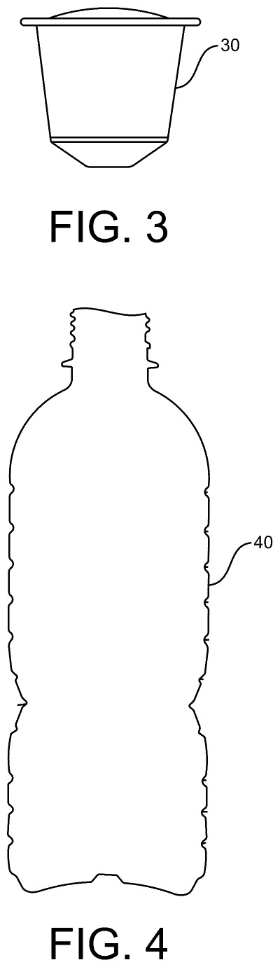

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

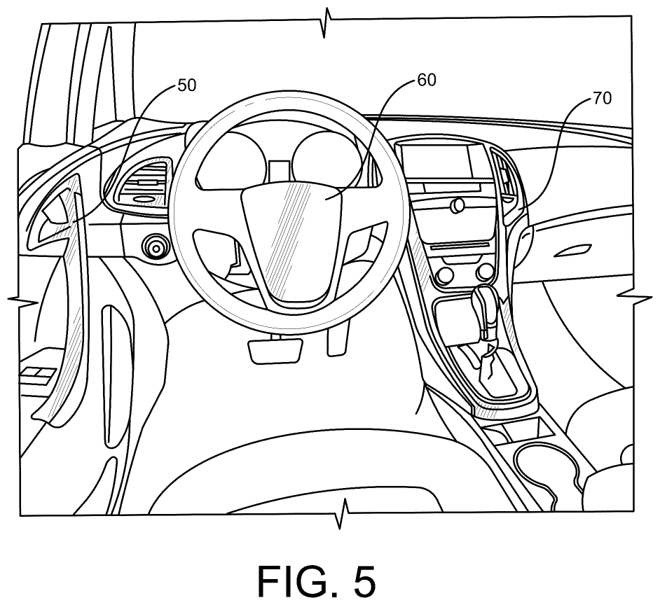

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

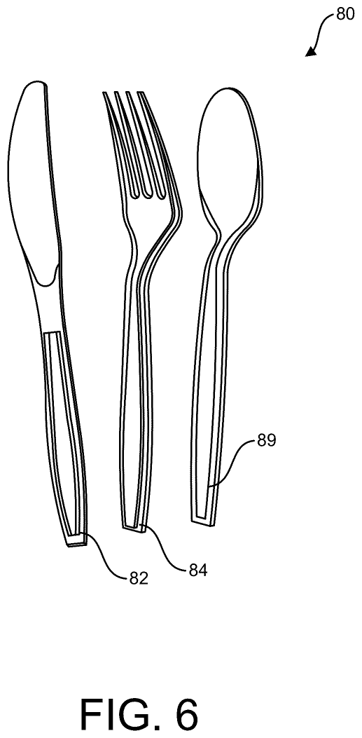

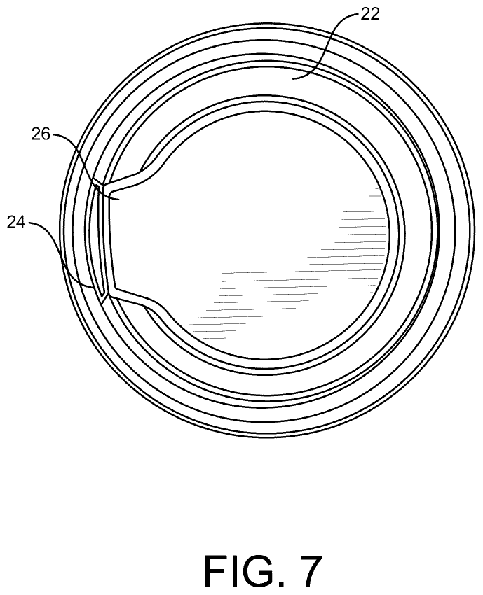

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

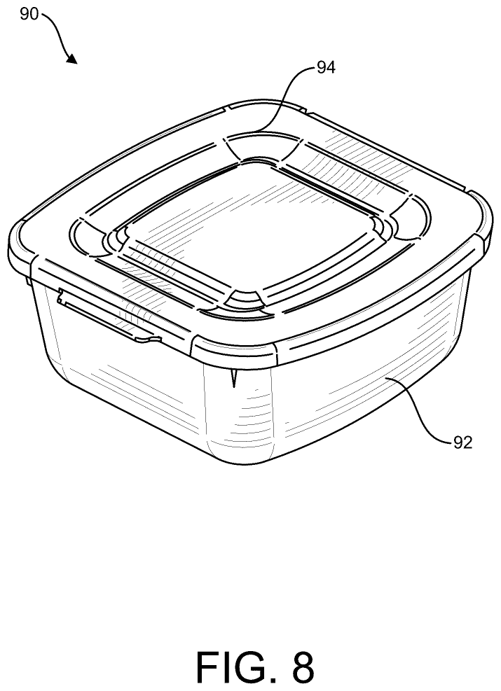

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

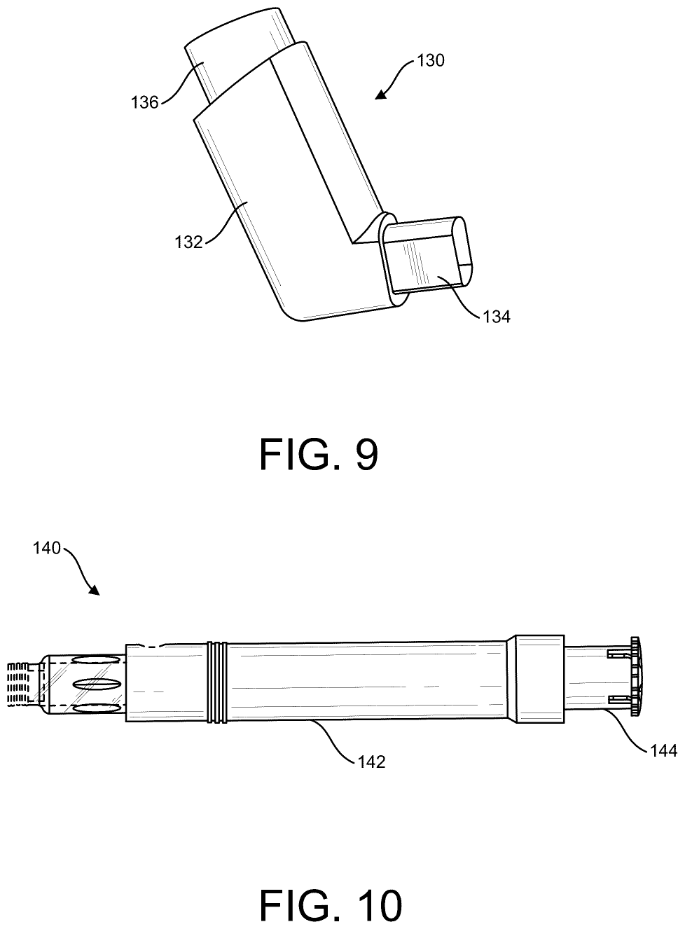

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

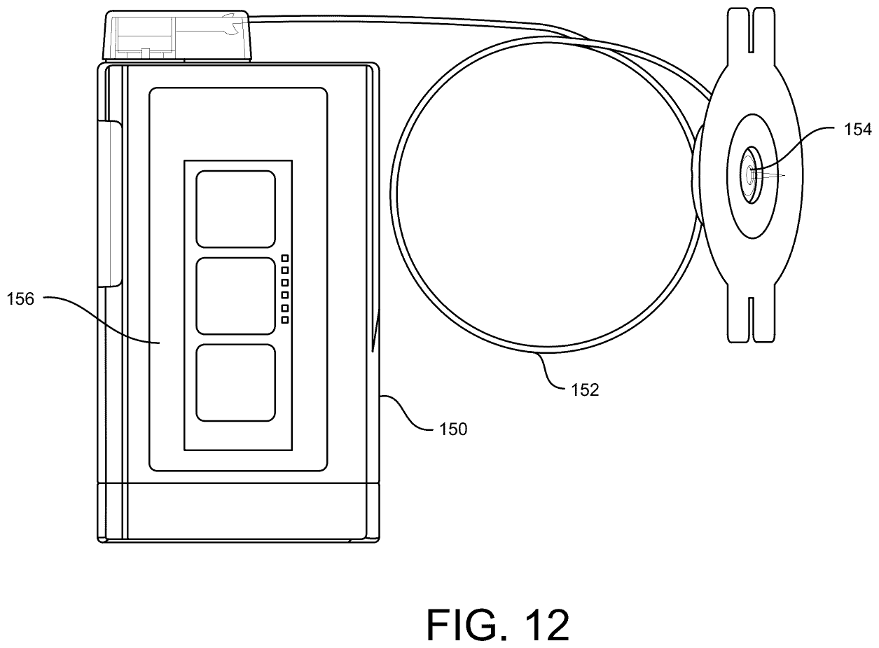

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

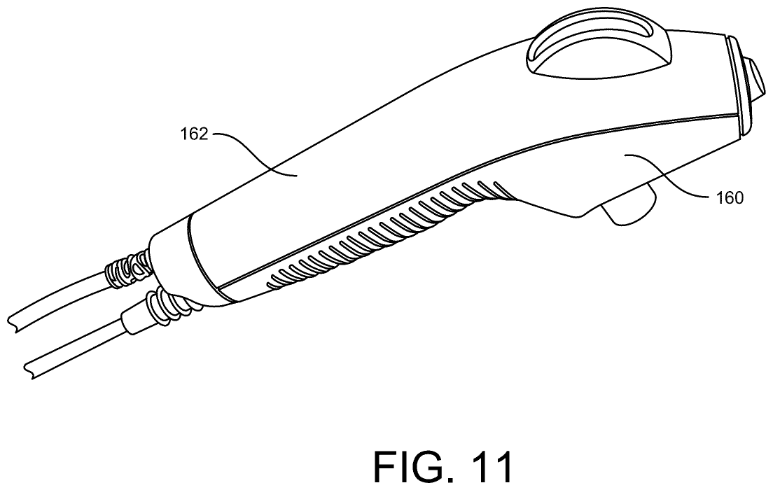

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

Molded articles can be made from the polymer composition of the present disclosure using any suitable method or technique. For example, fibers and films can be formed through extrusion. Cast films can also be formed. In other embodiments, the molded articles can be formed through injection molding or blow molding.

In one embodiment, the polymer composition can be first formed into a film and then thermoformed into an article.

During thermoforming, the film substrate is heated and then manipulated into a desired three-dimensional shape. The substrate can be formed over a male mold or a female mold. There are two main types of thermoforming typically referred to as vacuum forming or pressure forming. Both types of thermoforming use heat and pressure in order to form a film substrate into its final shape. During vacuum forming, a film substrate is placed over a mold and vacuum is used to manipulate it into a three-dimensional article. During pressure forming, pressure optionally in combination with vacuum forces are used to mold the film substrate into a shape.

The use of thermoforming to produce three-dimensional articles has various advantages. For instance, thermoforming allows for the production of all different types of shapes with fast turnaround times. Modifications to designs can also occur quickly and efficiently. Thermoforming can also be cost effective and can produce articles having an aesthetic appearance.

The temperature and pressure to which the foam substrate is subjected during the thermoforming process can vary depending upon various different factors including the thickness of the foam substrate and the type of product being formed. In general, thermoforming may be conducted at a temperature of from about 75° to about 120°, such as from about 75° to about 100°. Higher temperatures, however, can also be used. As described above, the foam substrate is also subjected to pressure and/or suction forces that press the foam substrate against a mold for conforming the foam substrate to the shape of the mold. Once molded, the three-dimensional article can be trimmed and/or polished as desired.

The present disclosure may be better understood with reference to the following example.

### Example

Various different polymer compositions were formulated and tested for various properties. The following example demonstrates some of the advantages and benefits of polymer compositions made according to the present disclosure.

More particularly, various cellulose ester polymer compositions were formulated, formed into ISO Test plaques and tested for various properties. The strength adjuvants, calcium carbonate and talc, were added to the polymer compositions at increasing levels. The cellulose ester polymer was a cellulose diacetate. The plasticizer used was triacetin and was added to the polymer composition such that the weight ratio between cellulose acetate and triacetin was 70:30. For each formulation, citric acid was added in an amount of 0.02% by weight, ethyl vanillin was added in an amount of 0.05% by weight, and Bis (2,4-dicumylphenyl) pentaerythritol diphosphite was added in an amount of 0.095% by weight.

The following tests were conducted on the compositions (using the most recent addition of the standardized tests):

| | |
|---|---|
| Density | ISO1183 |
| Melt Index (MI) | ISO1133 |
| Tensile Stress at break and | ISO 527 |
| Tensile Modulus, 50 mm/min (MPa) | |
| Tensile Strain at break, 5 mm/min | ISO 527 |
| (%) | |
| Flexural Modulus and Flexural | ISO 178 |
| Strength, 23° C. (MPa) | |
| Charpy Notched or Unnotched | ISO 179 |
| Impact Strength, 23° C. (kJ/m\hat{ }2) | |
| DTUL @ 1.8 or 0.45 MPa (° C.) | ISO 75 |

The following results were obtained:

| | | Cellulose | | | | | |
|---|---|---|---|---|---|---|---|
| | Cellulose | Ester | | | | TGA | MI @ |
| | Ester | Polymer | Filler | Triacetin | Pz by | Weight | 210° C., |
| | Polymer/ | Loading | loading | loading | TGA | loss at | 2.16 Kg |
| Description | Triacetin | (%) | (%) | (%) | (%) | 190C (%) | (° C.) |
| 0% | 70/30 | 69.8 | 0 | 30 | 27.1 | 12.11 | 8.6 |
| 20% Talc | 70/30 | 55.8 | 20 | 24 | 23.2 | 8.93 | 4.7 |
| 35% Talc | 70/30 | 45.4 | 35 | 19.5 | 16.4 | 7.17 | 3 |
| 42.5% Talc | 70/30 | 40.1 | 42.5 | 17.2 | 14.5 | 5.14 | 2.6 |
| 50% Talc | 70/30 | 34.9 | 50 | 15 | 12.1 | 4.64 | 1.5 |
| 20% CaCO3 | 70/30 | 55.8 | 20 | 24 | 21.8 | 9.18 | 3.5 |
| 27.5% CaCO3 | 70/30 | 50.6 | 27.5 | 21.7 | 19.4 | 6.54 | 2.5 |
| 35% CaCO3 | 70/30 | 45.4 | 35 | 19.5 | 17.2 | 5.5 | 1.9 |
| 42.5% CaCO3 | 70/30 | 40.1 | 42.5 | 17.2 | 15.1 | 5.26 | 1.1 |
| 50% CaCO3 | 70/30 | 34.9 | 50 | 15 | 11.3 | 3.87 | 0.3 |

| | | | | | Charpy | Charpy | | |
|---|---|---|---|---|---|---|---|---|
| | | | Tensile | | Unnotched | Notched | | |
| | Tensile | Tensile | Strain at | Flexural | Impact | Impact | DTUL | DTUL |
| Density | Modulus | Stress | Break | Modulus | Strength | Strength | @0.45 MPa | @1.8 MPa |
| (g/cc) | (MPa) | (MPa) | (%) | (MPa) | (KJ/m2) | (KJ/m2) | (° C.) | (° C.) |
| 1.29 | 2000 | 32.59 | 15.73 | 2086 | 121.3 | 12.8 | 58.5 | 43.7 |
| 1.4 | 3995 | 38.98 | 8.73 | 4187 | 86.9 | 6.1 | 71.7 | 57.4 |
| 1.47 | 6229 | 46.95 | 4.05 | 6638 | 31.8 | 3.4 | 76.2 | 60.2 |
| 1.52 | 7318 | 50.17 | 2.14 | 8014 | 15.2 | 2.4 | 79.4 | 65.7 |
| 1.67 | 8674 | 52.11 | 1.21 | 9610 | 9 | 1.9 | 84.8 | 69.7 |
| 1.44 | 2682 | 34.67 | 14.01 | 2716 | 107.4 | 5.5 | 60.9 | 48.2 |
| 1.5 | 3027 | 34.96 | 13.47 | 3057 | 73.6 | 3.5 | 64.8 | 51.3 |
| 1.56 | 3411 | 33.85 | 10.92 | 3510 | 46.1 | 3 | 67.7 | 52.5 |
| 1.61 | 4183 | 37.37 | 4.97 | 4438 | 23.4 | 2 | 74.3 | 53.8 |
| 1.65 | 5486 | 43.76 | 1.55 | 5824 | 10.9 | N/A | 83.7 | 66.4 |

As shown above, samples made according to the present disclosure had dramatically improved strength properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a cellulose ester polymer;
a plasticizer; and
one or more strength adjuvants, each strength adjuvant comprising filler particles, the one or more strength adjuvants being present in the polymer composition in an amount greater than 20% by weight and wherein the polymer composition displays a tensile strength of greater than about 35 MPa and a tensile modulus of greater than about 3,000 MPa.

2. A polymer composition as defined in claim 1, wherein the one or more strength adjuvants comprise mineral fillers.

3. A polymer composition as defined in claim 1, wherein the one or more strength adjuvants are present in the polymer composition in an amount greater than 30% by weight and in an amount less than about 55% by weight.

4. A polymer composition as defined in claim 1, wherein the polymer composition displays a tensile strength of greater than about 38 MPa.

5. A polymer composition as defined in claim 1, wherein the polymer composition displays a tensile strength of greater than about 42 MPa.

6. A polymer composition as defined in claim 1, wherein the polymer composition displays a tensile modulus of greater than about 3,500 MPa.

7. A polymer composition as defined in claim 1, wherein the one or more strength adjuvants comprises a magnesium compound, an aluminum compound, a zinc compound, a calcium compound, or mixtures thereof.

8. A polymer composition as defined in claim 1, wherein the one or more strength adjuvants comprises a magnesium compound.

9. A polymer composition as defined in claim 8, wherein the magnesium compound comprises a hydrated magnesium silicate.

10. A polymer composition as defined in claim 8, wherein the magnesium compound comprises a hydrotalcite.

11. A polymer composition as defined in claim 1, wherein the one or more strength adjuvants comprises calcium carbonate.

12. A polymer composition as defined in claim 1, wherein the one or more strength adjuvants comprises magnesium oxide, zinc oxide, or mixtures thereof.

13. A polymer composition as defined in claim 1, wherein the polymer composition contains at least two strength adjuvants.

14. A polymer composition as defined in claim 1, wherein the one or more strength adjuvants comprises a zeolite.

15. A polymer composition as defined in claim 1, wherein the polymer composition displays a DTUL at 1.8 MPa of greater than about 50° C.

16. A polymer composition as defined in claim 1, wherein the cellulose ester polymer is present in the polymer composition in an amount of from about 28% by weight to about 50% by weight, the plasticizer being present in the polymer composition in an amount from about 10% by weight to about 28% by weight, and the one or more strength adjuvants being present in the polymer composition in an amount from about 30% by weight to about 55% by weight.

17. A polymer composition as defined in claim 1, wherein the plasticizer comprises triacetin.

18. A polymer composition as defined in claim 1, wherein the plasticizer comprises a polycaprolactone or a polyethylene glycol.

19. An article made from the polymer composition as defined in claim 1.

20. An article as defined in claim 19, wherein the article comprises cutlery, a beverage holder, a drinking straw, a hot beverage pod, packaging, a container, a lid, an interior automotive part, or a consumer appliance part.
